(19) United States
(12) Patent Application Publication
(10) Pub. No.: US 2008/0178611 A1
(43) Pub. Date: Jul. 31, 2008

(54) Ecological Liquefied Natural Gas (LNG) Vaporizer System

(75) Inventor: James S. Ding, Houston, TX (US)

Correspondence Address: HELLER EHRMAN LLP, 1717 RHODE ISLAND AVE, NW, WASHINGTON, DC, 20036-3001, US

(73) Assignee: Foster Wheeler USA Corporation, Houston, TX (US)

(21) Appl. No.: 11/668,817

(22) Filed: Jan. 30, 2007

(51) Int. Cl. F17C 9/02

(52) U.S. Cl. 62/50.2

(57) ABSTRACT

An approach is provided for vaporizing liquefied natural gas (LNG). A system utilizing closed circulation of a heat transfer medium heated by ambient air and waste heat from a waste heat source vaporizes the LNG.

### BACKGROUND OF THE INVENTION

1. Field of the Invention

The present invention relates to an approach for vaporizing liquefied natural gas (LNG) utilizing closed circulation of a heat transfer medium heated by ambient air and waste heat from at least one waste heat source.

2. Description of the Related Art

Liquefied natural gas (LNG) has been playing an important role in the recent energy market. Most major energy concerns have been aggressively developing the liquefaction facilities at remote natural gas producing locations starting from the beginning of the twenty-first century. Immediately following the completion of the liquefaction plants, receiving and regasification terminals became inevitable necessities at the energy consumer areas. There are more than 30 LNG terminals in North America. Currently, these LNG terminals have proposed using open-rack vaporization (ORV) for LNG vaporization. However, these facilities cannot proceed because of environmental concerns for using seawater as a heat transfer medium for vaporization.

LNG regasification is quite different from that of other liquefied gases, such as nitrogen, in process quantity and operational aspects. Consequently, facilities designed for the regasification of other liquefied gases are inadequate for regasification of LNG.

Therefore, there is a need for a system and method for regasifying LNG that is efficient, economical, compact and harmless to the environment.

### SUMMARY OF THE INVENTION

These and other needs are addressed by the present invention, in which a system and method are provided for vaporization of LNG. The system for vaporizing LNG comprises a circulating heat transfer medium heated by existing heat sources to vaporize LNG. The method for vaporizing LNG comprises circulating the heat transfer medium through these heat sources to vaporize LNG.

In one aspect of the present invention, the system for vaporizing LNG comprises a heat transfer medium comprising glycol, water and alcohol. The system also comprises an expansion tank for heat transfer medium volume surging and pump suction. The system further comprises at least one circulation pump for heat transfer medium circulation. The system additionally comprises at least one air heater for heating the heat transfer medium to close to ambient temperature. The system next comprises at least one heat recovery unit to recover waste heat from at least one waste heat source. The system further comprises at least one shell and tube heat exchanger for vaporizing LNG to natural gas.

In another aspect of the present invention, a method for vaporizing LNG is disclosed. The method comprises circulating a heat transfer medium comprising glycol, water and alcohol from an expansion tank to at least one air heater. The method further comprises heating the heat transfer medium using the at least one air heater to about ambient temperature. The method next comprises circulating the heat transfer medium from the at least one air heater to at least one heat recovery unit, the at least one heat recovery unit recovering waste heat from at least one waste heat source. The method additionally comprises heating the heat transfer medium using the at least one heat recovery unit. The method then comprises circulating the heat transfer medium from the at least one heat recovery unit through the shell portion of at least one shell and tube heat exchanger. The method additionally comprises pumping the LNG from a storage tank or an intake to the tube portion of the at least one shell and tube heat exchanger to vaporize the LNG to natural gas. The method also comprises circulating the heat transfer medium back to the expansion tank for volume surging.

### BRIEF DESCRIPTION OF THE DRAWING

The present invention is illustrated by way of example, and not by way of limitation, in the figure of the accompanying drawing and in which like reference numerals refer to similar elements and in which:

FIG. 1 is a diagram of a system for vaporizing LNG in accordance with an embodiment of the present invention.

### DETAILED DESCRIPTION OF THE PREFERRED EMBODIMENTS

A system and method for vaporizing LNG are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

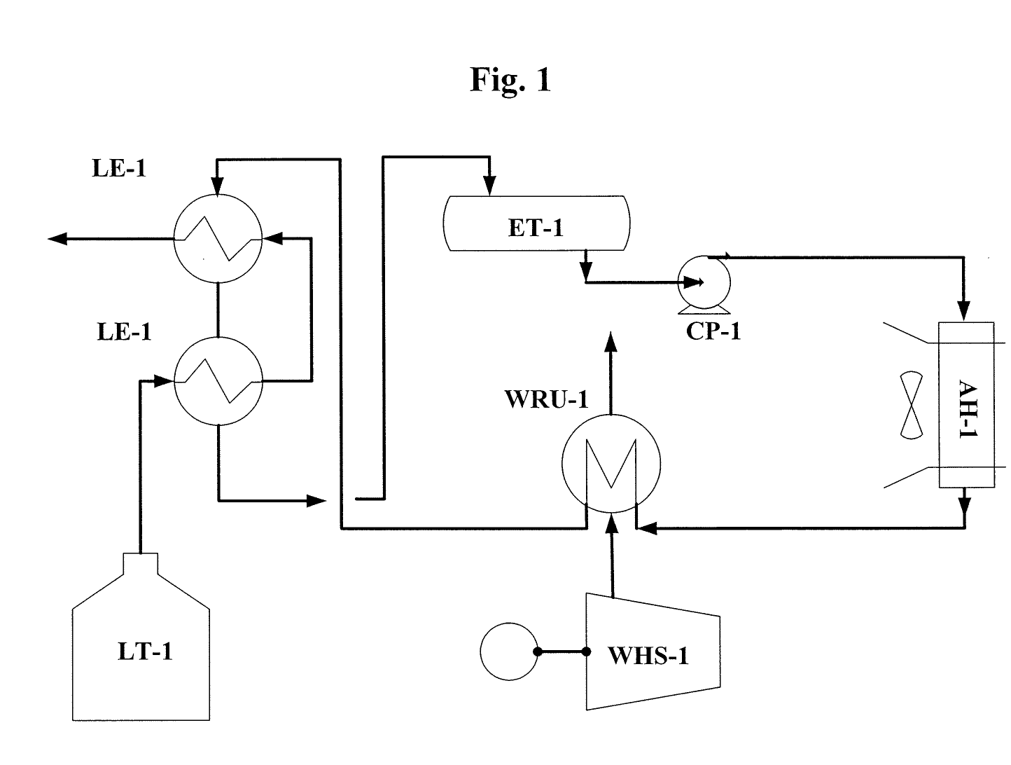

FIG. 1 is a diagram of a system for vaporizing LNG in accordance with an embodiment of the present invention. An expansion tank ET-1 stores a mixture of water, glycol and alcohol as a heat transfer medium. The expansion tank ET-1 comprises an atmospheric, gas-blanketed, carbon steel for heat transfer medium volume expansion and pump suction for temperatures from about 30° F. to about 150° F. at a pressure of about 10 psig. The expansion tank ET-1 comprises an inlet/outlet, auto/manual fill nozzles, level indication/control devices and a personnel protection guard without insulation. The glycol comprises ethylene glycol. The alcohol comprises methanol/ethanol. The heat transfer medium has a freezing temperature below about −40° F. but operates in the system with the lowest temperature about −20° F. At least one circulation pump CP-1 circulates the heat transfer medium from the expansion tank ET-1. The circulation pump comprises a high volume, low head pump.

The circulation pump CP-1 sends the heat transfer medium to at least one air heater AH-1. The air heater AH-1 comprises a fin-fan heat exchanger that exchanges heat contained in ambient air blown into the fins of the air heater AH-1 to heat the heat transfer medium flowing through the air heater AH-1. The air heater AH-1 operates at a temperature from about −20° F. to about 150° F. at a pressure of about 150 psig. The heat transfer medium is heated by the air heater AH-1 from below ambient temperature to close to ambient temperature. From about 50% to about 80% of the heat required for the heat transfer medium to vaporize the LNG is obtained from the air heater AH-1.

The heat transfer medium is circulated from the at least one air heater AH-1 to at least one waste heat recovery unit WRU-1. The waste heat recovery unit comprises a water tube type waste heat recovery unit for exhaust gas heat recovery from at least one waste heat source WHS-1 and/or at least one fired heater. From about 20% to about 50% of the heat required for the heat transfer medium to vaporize the LNG is obtained from the waste heat recovery unit WRU-1. For cooler ambient conditions, the waste heat recovery unit may recover auxiliary duct fired heat. Up to this point, the system does not require cryogenic service like Atmospheric Air Vaporizers (AAV) and Open Rack Vaporizers (ORV).

The heat transfer medium is circulated from the at least one waste recovery unit to the shell side of at least one shell and tube heat exchanger LE-1. The LNG is pumped from an intake or a storage tank LT-1 through the tube side of the at least one shell and tube heat exchanger LE-1 for vaporization into natural gas. After circulation through the shell side of the shell and tube heat exchanger LE-1, the transfer medium is circulated back to the expansion tank ET-1 for volume surging.

Accordingly, an efficient, economical, compact and harmless to the environment system and method for vaporizing LNG is disclosed.

While the present invention has been described in connection with a number of embodiments and implementations, the present invention is not so limited but covers various obvious modifications and equivalent arrangements, which fall within the purview of the appended claims.

What is claimed is:

1. A system for vaporizing liquefied natural gas (LNG) comprising:
a heat transfer medium comprising glycol, water and alcohol;
an expansion tank for heat transfer medium volume surging and pump suction;
at least one circulation pump for heat transfer medium circulation;
at least one air heater for heating the heat transfer medium to close to ambient temperature;
at least one heat recovery unit to recover waste heat from at least one turbo generator; and
at least one shell and tube heat exchanger for vaporizing LNG to natural gas.

2. The system according to claim 1, wherein the heat transfer medium comprises ethylene glycol.

3. The system according to claim 1, wherein the heat transfer medium comprises methanol/ethanol.

4. The system according to claim 1, wherein the heat transfer medium has a freezing temperature below about −40° F.

5. The system according to claim 1, wherein the heat transfer medium operating temperature is around −20° F.

6. The system according to claim 1, wherein the expansion tank comprises carbon steel for volume expansion of the heat transfer medium at temperatures between about −30° F. and 150° F. at a pressure of about 10 psig.

7. The system according to claim 6, wherein the expansion tank is gas-blanketed and comprises an inlet/outlet, auto/manual fill nozzles, level indication/control devices and a personnel protection guard without insulation.

8. The system according to claim 1, wherein the at least one circulation pump comprises a high-volume, low-head, pump.

9. The system according to claim 1, wherein the at least one circulation pump circulates the heat transfer medium from the expansion tank to at least one air heater.

10. The system according to claim 9, wherein the heat transfer medium is heated by the at least one air heater to about ambient temperature, wherein the at least one air heater is a fin-fan heat exchanger with ambient air.

11. The system according to claim 10, wherein the heat transfer medium is further circulated from the at least one air heater to at least one heat recovery unit, wherein the at least one heat recovery unit further heats the heat transfer medium.

12. The system according to claim 11, wherein the heat transfer medium is heated between about 50% to about 100% by the at least one air heater.

13. The system according to claim 11, wherein the heat transfer medium is heated between about 0% to 50% by the at least one heat recovery unit.

14. The system according to claim 1, wherein the at least one heat recovery unit recovers waste heat from at least one waste heat source.

15. The system according to claim 11, wherein the heat transfer medium is circulated from the at least one heat recovery unit to the shell side of at least one shell and tube heat exchanger and wherein the LNG is pumped through the tube side of the at least one shell and tube heat exchanger for vaporization into natural gas.

16. A method for vaporizing liquefied natural gas (LNG) comprising:
circulating a heat transfer medium comprising glycol, water and alcohol from an expansion tank to at least one air heater;
heating the heat transfer medium using the at least one air heater to about ambient temperature;
circulating the heat transfer medium from the at least one air heater to at least one heat recovery unit, the at least one heat recovery unit recovering waste heat from at least one waste heat source;
heating the heat transfer medium using the at least one heat recovery unit;
circulating the heat transfer medium from the at least one heat recovery unit through the shell side of at least one shell and tube heat exchanger;
pumping the LNG from a storage tank to the tube side of the at least one shell and tube heat exchanger to vaporize the LNG to natural gas; and
circulating the heat transfer medium back to the expansion tank for volume surging.

17. The method according to claim 16, wherein the heat transfer medium comprises methanol/ethanol.

18. The method according to claim 16, wherein the heat transfer medium is mixed for a freezing temperature below about −40° F.

19. The method according to claim 16, wherein the heat transfer medium is heated between about 50% to about 100% by the at least one air heater.

20. The method according to claim 16, wherein the heat transfer medium is heated between about 0% to 50% by the at least one heat recovery unit.
